(19) United States
(12) Patent Application Publication
(10) Pub. No.: US 2013/0063316 A1
(43) Pub. Date: Mar. 14, 2013

(54) COMPACTED PATCH ANTENNA

(71) Applicants: Guido Moiraghi, Milano (IT); Luca Moiraghi, Milano (IT); Paolo Moiraghi, Marcignago (PV) (IT)

(72) Inventors: Guido Moiraghi, Milano (IT); Luca Moiraghi, Milano (IT); Paolo Moiraghi, Marcignago (PV) (IT)

(21) Appl. No.: 13/699,133

(22) PCT Filed: May 20, 2011
(86) PCT No.: PCT/EP11/58253

§ 371 Date: Nov. 20, 2012

Related U.S. Application Data
(60) Provisional application No. 61/350,968, filed on Jun. 3, 2010.

(30) Foreign Application Priority Data
May 21, 2010 (IT) MI2010A 000914

(51) Int. Cl. H01Q 1/38; H01Q 1/50; H01Q 1/32

(52) U.S. Cl. 343/713; 343/700 MS; 343/717; 343/860

(57) ABSTRACT

A compacted patch antenna is described, particularly for installation in a vehicle, comprising an electrically supplied strip radiating element and a ground plane. The strip radiating element is connected to the ground plane at a first end by means of a metal link and at a second end, opposite to the first end, by means of a variable capacitor. The compacted patch antenna comprises a printed circuit, the bottom surface of which is integral with the ground plane, a dielectric material layer arranged between the strip radiating element and the printed circuit; the strip radiating element is substantially parallel to the ground mass. The dielectric material layer has a relative dielectric constant ranging between 3 to 6 with a loss factor ranging between 0.03 to 0.1.

The present invention relates to a compacted patch antenna.

Patch antennas, also known as rectangular micro-strip antennas, are known in the state of the art. They consist of a single metal patch suspended over a ground plane and a dielectric substrate arranged between the ground plane and the metal patch; the antenna assembly is generally contained in a plastic cover which protects the antenna against possible damages. They are used in various applications as they have a compact and light structure, a low profile, a geometry conformable to the surfaces and finally are easily interfaceable with the signal supply network (which may comprise amplifiers, filters and/or power dividers). Disadvantages include medium-low efficiency (due to low-cost materials), an intrinsically narrow operating band (due to the resonant-type operation) and the non-remote possibility of exciting surface waves in the substrate, which are sources of spurious radiation. The operation of the patch antenna is of resonant type and the resonance frequency mainly depends on shape and size of the printed region and on the dielectric constant of the substrate. Instead, the input impedance depends on the supply point, whereby a mode should be selected for supplying the antenna which takes the signal close to the point corresponding to the desired impedance.

The metal patch has a length equal to half the wavelength if the antenna is used in radiofrequency. The micro-strip antennas have various advantages as compared to conventional microwave antennas, since they may easily cover a wide range of frequencies, typically from 100 MHz to 100 GHz. Said antennas have a low weight, a small volume, a high mechanical sturdiness and a low production cost. However, they have certain disadvantages related to the narrow band and to the quite low gain, about six decibels; the band may be increased by using high-permittivity dielectric layers and the gain may be increased with micro-strip antenna arrays.

Radiation phenomena of a micro-strip line are known to be significantly reduced if the substrate employed is thin and has a high permittivity. For these reasons, low-permittivity thick substrates are preferred when micro-strip antennas with high irradiation efficiency are to be provided.

The length of the patch strongly determines the resonant frequency and is a critical parameter in determining the band; indeed, typically a micro-strip antenna has a much smaller bandwidth as compared to that of a normal resonant antenna. The increased height of the substrate and a smaller dielectric constant may increase the bandwidth, but this could lead to geometrical parameters which are incompatible with the integration scale chosen. To a first approximation, the resonant frequency is inversely proportional both to the length and to the square root of the relative permittivity of the dielectric. Since width and length for a real patch have a finite measure, the fields at the edges are subject to fringing effect. This effect is due to the field lines being required to pass through a non-homogeneous medium consisting of two separate dielectrics: substrate and air.

There are other patch antennas which are highly used in wireless transmissions, having a length equal to ¼ of the wavelength and having the radiating metal patch short-circuited to the ground plane, such as PIFA antennas (Planar Inverted F-Antennas).

In view of the state of the art, it is the object of the present invention to provide a compacted patch antenna which is different from the known antennas. The antenna in accordance with the invention has small dimensions and preferably a high selectivity of the bandwidth at the resonant frequency.

In accordance with the present invention, said object is achieved by a compacted patch antenna, in particular to be installed in a motor vehicle, comprising an electrically supplied strip radiating element, a ground plane to which said strip radiating element is connected at a first end by means of metal link, and at a second end opposite to the first end, by means of a variable capacitor, a printed circuit the bottom surface of which is integral with the ground plane, a dielectric material layer arranged between the strip radiating element and the printed circuit, said strip radiating element being substantially parallel to said ground plane, characterized in that said dielectric material layer has a relative dielectric constant ranging from 3 to 6 and a loss factor ranging from 0.03 to 0.1.

The features and advantages of the present invention will become apparent from the following detailed description of a practical embodiment thereof, shown by way of non-limiting example in the accompanying drawings, in which:

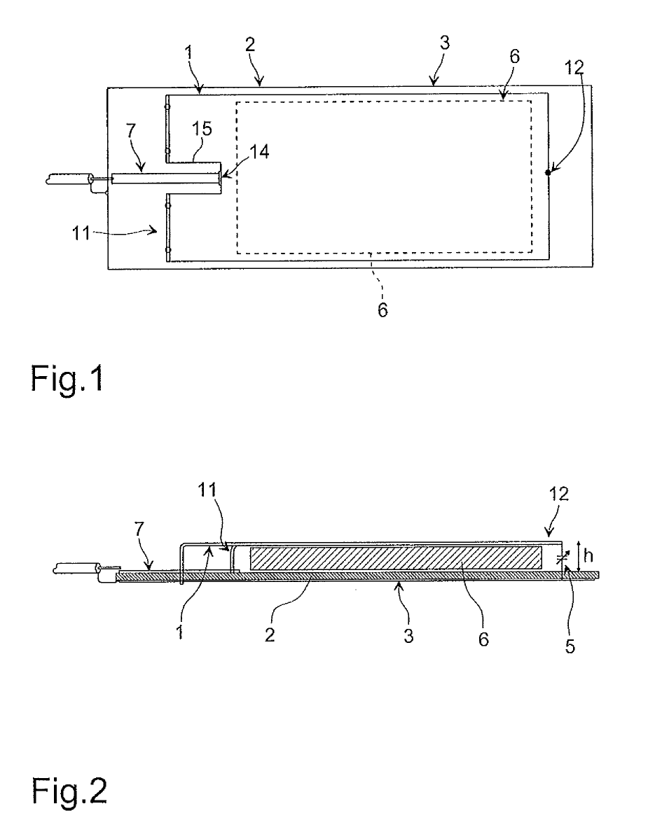

FIG. 1 is a top view of the compacted patch antenna in accordance with an embodiment of the present invention;

FIG. 2 is a diagrammatic, cross-section view of the antenna in FIG. 1;

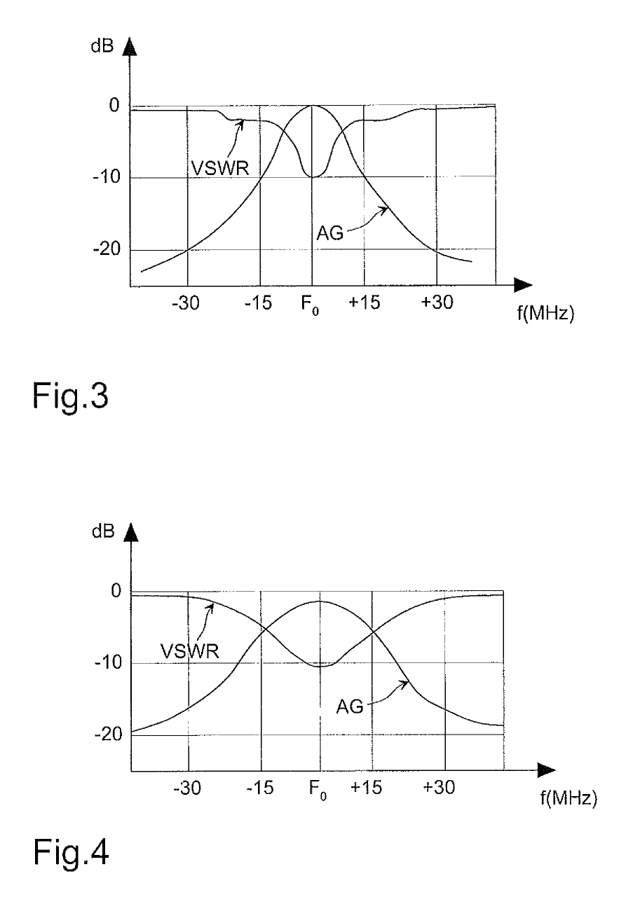

FIGS. 3 and 4 show diagrams of the gain of the antenna in FIG. 1 according to the frequency;

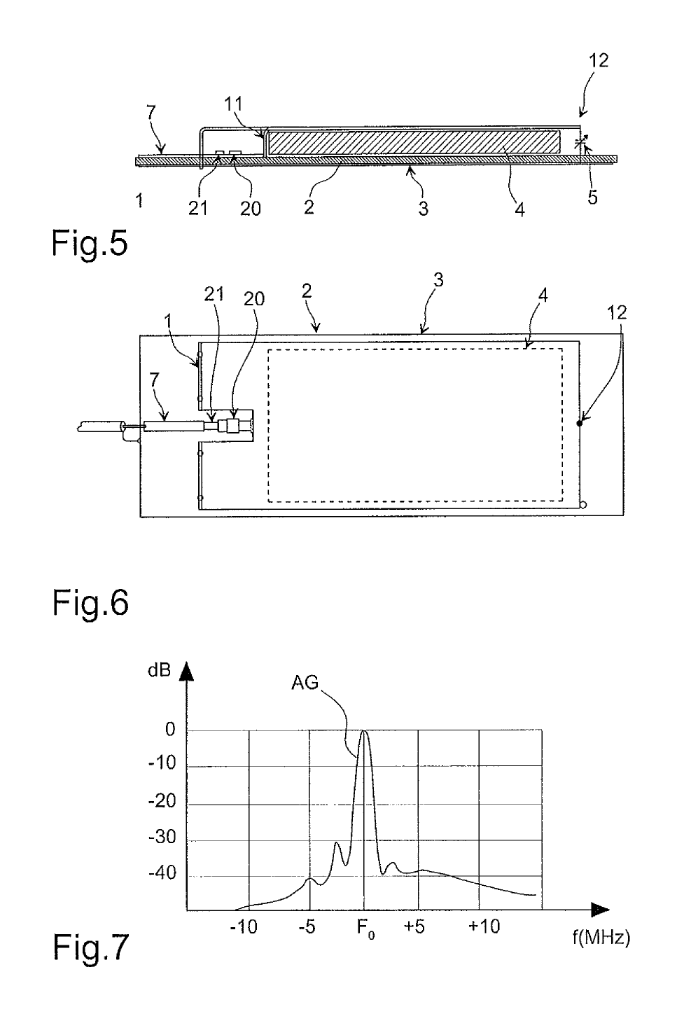

FIG. 5 shows a diagrammatic, cross-section view of the compacted patch antenna in accordance with a variant of the embodiment of the present invention;

FIG. 6 is a top view of the compacted patch antenna in FIG. 5;

FIG. 7 shows a diagram of the gain of the antenna in FIG. 5 according to the frequency;

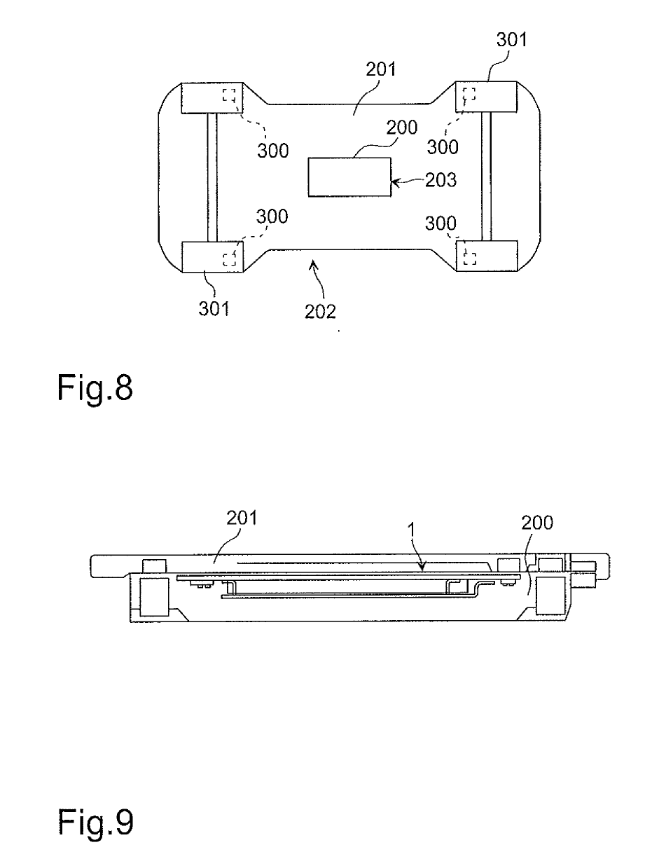

FIG. 8 shows a motor vehicle in which the compacted patch antenna in FIG. 1 or FIG. 5 has been installed;

FIG. 9 shows the compacted patch antenna in FIG. 1 or FIG. 5 in greater detail, fixed to the motor vehicle.

With reference to FIGS. 1 and 2, a compacted patch antenna is shown in accordance with an embodiment of the present invention. The antenna comprises a strip radiating metal element or micro-strip 1 preferably having a length equal to ¼ of the wavelength of the resonant frequency, e.g. of the frequency Fo=434 MHz. Said strip metal element 1 is connected to ground GND at one end 11, and at the opposite end 12 is connected to a variable capacitor 5 connected to ground; said variable capacitor 5 is adjusted to tune the resonant circuit of the antenna to the resonance on the operating frequency.

The antenna comprises a flat base 2 with a printed circuit, the completely coppered bottom face of which is the ground plane 3; the strip metal element 1 is parallel to the ground plane 3. The height h of the antenna with respect to the ground plane is about 7 mm; the space between the strip metal element 1 and the ground plane 3 is partially filled with the material of the printed circuit and partially with dielectric material 6 with suitable dielectric constant and suitable loss factor. The dielectric material 6, in particular plastics, is glued to the strip radiating element 1 and to the flat base 2 with printed circuit, thus obtaining a rigid, firm planar structure even in the presence of detectable, strong mechanical vibrations, for example if the antenna is installed in a car.

The antenna comprises a small micro-strip 7 integral with the strip metal element 1 and adapted to supply the antenna; the impedance matching is also performed through micro-strip 7. In particular, the strip metal element 1 comprises a small rectangular split 15 on the side of end 11 which continues towards end 12. Split end 14 is the contact point between micro-strip 7 and metal element 1.

The geometry of the compacted patch antenna in accordance with the invention is of rectangular type, but so that metal element 1 is larger than dielectric layer 6 and smaller than printed circuit 2 with ground plane 3.

The dielectric material layer 6 has a relative dielectric constant ∈ᵣ ranging between 3 to 6 which allows the size of the patch antenna to be reduced; indeed, a metal strip element may be used, having a length equal to ¼ of the wavelength, while the thickness of the antenna is less than one centimetre.

Moreover, the dielectric material layer 6 has a loss factor tank ranging from 0.03 to 0.1, preferably from 0.05 to 0.1, which allows the bandwidth to be increased to the resonant frequency of the antenna, i.e. allows the bandwidth to be tuned to the resonant frequency thereof without invalidating the proper operation of the antenna. Indeed, with a dielectric material with a loss factor tank less than 0.03 (e.g. 0.01), a very critical antenna would be obtained, which would be difficult to manufacture and calibrate, and which could lose its resonant frequency over the life of the antenna. There is no need—especially in the field of motor vehicle or automotive applications—for the bandwidth about the resonant frequency to be narrow in order not to invalidate the proper operation of the antenna over the years; an antenna with a very narrow bandwidth would be critical and the resonant frequency thereof could significantly vary due to the mechanical and thermal stresses found on motor vehicles, for example. In particular, the choice of a loss factor tank of the dielectric material ranging between 0.05 to 0.1 allows a good balance between the need for an antenna with a bandwidth such as to decrease undesired disturbances and signals on the one hand, and the need for an antenna which is easy to manufacture and calibrate, and especially which has a long life, on the other hand. For example, certain dielectric materials which may be used to fill the space between metal element 1 and ground plane 3 are FR4 material (Glass Reinforced Epoxy) with dielectric constant 4.7 and loss factor 0.03, and especially PMMA material (Poly Methyl Metacrylate) with dielectric constant 3.7 and loss factor 0.06, or ABS material (Acrylonitrile Butadiene Styrene) with dielectric constant 3.5 and loss factor 0.09.

The antenna exhibits a resonance tuned to a frequency ranging between 300 megahertz to 1 gigahertz and the dielectric material allows the bandwidth to be tuned to match it to the various application needs. However, there is a need for the bandwidth to be at least equal to or greater than 15 MHz.

FIG. 3 shows the anti-gain diagrams of AG antenna and VSWR (Voltage Standing Wave Ratio), i.e. a parameter which denotes, in decibels, the ratio between the maximum and minimum voltage values of a stationary wave pattern according to the frequency if the dielectric is the PMMA material; the bandwidth centred on the resonant frequency Fo=434 MHz is 15 MHz with a gain of some decibels.

FIG. 4 shows the anti-gain diagrams of AG antenna and VSWR, in decibels, according to the frequency if the dielectric is the ABS material; the bandwidth centred on the resonant frequency Fo=434 MHz is 25 MHz with a gain of some decibels but less than the gain of the antenna in FIG. 3.

A compacted patch antenna in accordance with a variant of the embodiment of the present invention is shown in FIGS. 5 and 6. Said antenna differs from the antenna in FIGS. 1 and 2 due to the presence of a SAW filter 20 with the corresponding impedance matching circuit 21, coupled with the small micro-strip 7 which allows the antenna to be supplied.

The SAW filter 20 allows the antenna selectivity to be increased, in particular if the antenna is used in a car while keeping the features of mechanical stability and high reliability of the antenna, as shown in the anti-gain diagram of the AG antenna in FIG. 7 with bandwidth centred on the resonant frequency Fo=434 MHz.

The antenna in accordance with the present invention is adapted to be used in data transmitting and receiving systems for vehicles, preferably for motor vehicles. The antenna is first arranged within an airtight, plastic cover 200 which is fixed to the frame 201 of a motor vehicle 202, preferably to the outer surface of the bottom of frame 201 of motor vehicle 202, in particular in the middle part 203 of the bottom of frame 201, as shown in FIGS. 8 and 9; plastic cover 200 may be fixed to frame 201 of the motor vehicle simply by means of screws or bolts which are engaged with holes of the cover and with holes made on the outer surface of the bottom of the motor vehicle. The antenna is mainly configured to receive data transmitted from specific transmitters 300 for the pressure of tires 301, arranged inside the tires themselves; preferably, said transmitters are those described in patent application EP 1787831 by the same applicant. In particular, said transmitters are associated with the tire valves as described in the figures in patent application EP 1787831 and in the description thereof; each transmitter 300 is adapted to perform a pulse-position modulation (PPM) of the signal indicating the pressure of tire 301. The compacted patch antenna in accordance with the present invention is adapted to receive the impulse modulation signals from said transmitters 300. The compacted patch antenna in accordance with the invention is connected to a receiver (not shown in the figures) arranged inside the motor vehicle, to demodulate the signal received by the antenna.

1. A compacted patch antenna, particularly for installation in a vehicle, comprising an electrically supplied strip radiating element, a ground plane to which said strip radiating element is connected at a first end by means of metal link and at a second end, opposite to the first end, by means of a variable capacitor, a printed circuit the bottom surface of which is integral with the ground plane, a dielectric material layer arranged between the strip radiating element and the printed circuit, said strip radiating element being substantially parallel to said ground plane, characterized in that said dielectric material layer has a relative dielectric constant ranging from 3 to 6 and a loss factor ranging from 0.03 to 0.1.

2. The compacted patch antenna according to claim 1, characterized in that said strip radiating element has a length equal to ¼ of the wavelength.

3. The compacted patch antenna according to claim 1, characterized in that said dielectric material layer has a loss factor ranging between 0.05 to 0.1.

4. The compacted patch antenna according to claim 1, characterized in that the height of the antenna between the strip radiating element and the ground plane is less than 1 cm.

5. The compacted patch antenna according to claim 1, characterized in that the height of the antenna between the strip radiating element and the ground plane is substantially 7 mm.

6. The compacted patch antenna according to claim 1, characterized in that said strip radiating element comprises a split and said antenna comprises a metal link for electrically supplying the strip radiating element arranged inside said split and in contact with the inner edge of said split.

7. The compacted patch antenna according to claim 1, characterized in that it comprises a metal link for electrically supplying the strip radiating element connected to one end of the strip radiating element and a SAW filter with the corresponding impedance matching circuit connected between said end of the strip radiating element and said metal link.

8. The compacted patch antenna according to claim 1, characterized in that the antenna is configured to exhibit a resonance tuned to a frequency ranging from 300 megahertz to 1 gigahertz.

9. A vehicle comprising a frame and at least one pair of wheels provided with tires, at least one tire being provided with a transmitter of a signal indicating the tire pressure, said vehicle comprising an apparatus for receiving the at least one signal emitted from said at least one transmitter, said receiving apparatus comprising an antenna, characterized in that said antenna is connected to the frame of the vehicle and the antenna is the compacted patch antenna as claimed in claim 1.

10. The vehicle according to claim 9, characterized in that said antenna is connected to the outer surface of the bottom of the vehicle frame.

11. The vehicle according to claim 9, characterized in that said antenna is arranged in an airtight, plastic cover fixed to the frame of the vehicle.
